(19) United States
(12) Patent Application Publication
(10) Pub. No.: US 2026/0004605 A1
(43) Pub. Date: Jan. 1, 2026

(54) COMPUTER VISION-BASED ASSESSMENT OF POSTURE OF LIVING BODIES AND APPROACHES TO SURFACING INSIGHTS GAINED THEREFROM

(71) Applicant: Hinge Health, Inc., San Francisco, CA (US)

(72) Inventors: Abel Gonzalez Garcia, Montreal (CA); Caroline Rougier, Montreal (CA); Johannus Vogel, San Francisco, CA (US); Thien Bach Huynh, San Francisco, CA (US); Teagan Daly, San Francisco, CA (US); Claire Hsing, San Francisco, CA (US); Dongwook Cho, Montreal (CA); Joe Palmieri, San Francisco, CA (US)

(21) Appl. No.: 19/329,296

(22) Filed: Sep. 15, 2025

Related U.S. Application Data
(63) Continuation of application No. PCT/US24/25711, filed on Apr. 22, 2024.
(60) Provisional application No. 63/498,225, filed on Apr. 25, 2023.

(51) Int. Cl. G06V 40/10; G06V 10/77; G06V 10/82; G06V 20/40; G06V 40/60

(52) U.S. Cl. CPC G06V 40/10; G06V 10/7715; G06V 10/82; G06V 20/46; G06V 40/67

(57) ABSTRACT

Introduced here are computer-implemented platforms (also referred to as “therapy platforms”) that are designed to provide feedback for posture improvement. As part of a posture program, a user may be requested to engage with a therapy platform, which can capture image data of a user in an environment over a time period (e.g., a posture session) to analyze for posture feedback. Simultaneously to capturing the image data, the therapy platform can extract an estimated pose of a user based on the image data and determine a posture indicator based on the estimated pose. The therapy platform uses the posture indicator to render feedback and other content (e.g., visual instructions) for the user for improving her posture.

### CROSS-REFERENCE TO RELATED APPLICATIONS

This application is a continuation of International Application No. PCT/US2024/025711, titled “Computer Vision-Based Assessment of Posture of Living Bodies and Approaches to Surfacing Insights Gained Therefrom” and filed on Apr. 22, 2024, which claims priority to U.S. Provisional Application No. 63/498,225, titled “Computer Vision Based Posture Assessment” and filed on Apr. 25, 2024, each of which is incorporated herein by reference in its entirety.

### TECHNICAL FIELD

Various embodiments concern computer programs designed to improve performance of poses with various body parts and associated systems and methods.

### BACKGROUND

Exercise therapy is an intervention technique that utilizes physical activity as the principal treatment method for addressing the symptoms of musculoskeletal (MSK) conditions, such as acute physical ailments and chronic physical ailments. Exercise therapy programs may involve a plan for performing physical activities during exercise therapy sessions that occur on a periodic basis. Generally, the purpose of an exercise therapy program is to either restore normal MSK function or reduce the pain caused by an acute or chronic physical ailment, which may have been caused by injury or disease. As such, the physical activities to be performed in each exercise therapy session may be selected in order to achieve a specific therapeutic goal. Examples of therapeutic goals include lessening pain, improving flexibility, improving posture, rehabilitating injuries, managing diseases, and the like.

These exercise therapy programs normally depict how a user should perform one or more physical activities to achieve a specific therapeutic goal within a time period. However, these exercise therapy platforms usually are unable to monitor whether the user is properly performing the physical activities or guide the user based on how she is actually performing the physical activities. For example, if the user is not using the proper technique to perform a physical activity, she may not know that her technique is off. This can result in the user not experiencing improvement in her acute or chronic pain, flexibility, posture, or the like, causing the user to become discouraged from doing her exercise therapy sessions. Therefore, a better approach is needed for guiding users through physical activities such that users are able to achieve lasting improvement in terms of MSK function. The benefits of improved performance of poses are not limited to exercise therapy programs.

Other systems that facilitate training a user to perform physical activities may also be unable to monitor whether a user is properly performing a variety of physical activities, such as dance moves, sporting techniques, exercises, cooking techniques, and the like. For example, if a user is not using proper form for her forehands, she may not be as successful in tennis matches compared to if she were using proper form. In another example, a user may be penalized in a cooking competition for not cutting her vegetables in a specific manner, which system could have informed her with the ability to monitor her cutting technique. Thus, these systems need a way to monitor physical activities for users to achieve improved form.

### BRIEF DESCRIPTION OF THE DRAWINGS

FIG. 1 illustrates an example of a network environment that includes a therapy platform.

FIG. 2A illustrates an example of a computing device able to implement a program in which a user is requested to perform physical activities, such as exercises, during sessions by a therapy platform.

FIG. 2B illustrates an analysis module of the therapy platform of FIG. 2A.

FIG. 3A depicts an example of a communication environment that includes a therapy platform configured to receive several types of data.

FIG. 3B depicts another example of a communication environment that includes a therapy platform configured to obtain data from one or more sources.

FIG. 4 depicts a flow diagram of a process for determining feedback for a user based on posture indicators.

FIG. 5 depicts a flow diagram of a process for determining posture indicators.

FIG. 6A depicts a user interface with interactive elements for a user to select between to engage with a therapy platform.

FIG. 6B depicts a user interface with a description of a posture session for posture assessment.

FIG. 6C depicts a user interface including an image of how to place a computing device to capture image data for a posture session.

FIG. 6D depicts a user interface with a camera feed from an image sensor of a computing device.

FIG. 6E depicts a user interface with verification of computing device positioning for a posture session.

FIG. 6F shows a user interface including a timer depicting time remaining in a posture session.

FIG. 6G shows a user interface depicting the timer of FIG. 6F when a posture session is paused.

FIG. 6H depicts a user interface indicating that a user has completed posture assessment for the posture session.

FIG. 6I shows a user interface with feedback for a user after posture assessment for a posture session.

FIG. 7 is a block diagram illustrating an example of a processing system.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Sedentary work, especially when it includes long stretches of time under the same posture, is known to cause MSK pain. Without diligent attention or instructions on posture, persons may unknowingly spend many hours doing sedentary work, leading to back pain, neck pain, or other MSK pain. Introduced here are computer-implemented platforms that are designed to perform posture assessment. As an example, a computer-implemented platform (also called a “pose estimating platform,” “pose monitoring platform,” or “therapy platform”) can implement a program designed to analyze a person's posture. The program can capture a live video stream of the person while she works at a desk over a period of time. Simultaneously, the program can extract an estimated pose of the person and heuristically analyze the estimated pose to determine posture indicators. The program can give feedback to the person about how to improve her posture based on the posture indicators. At a high level, this feedback can “nudge” the person into improving her posture in a non-invasive, natural way. With good posture, the person can reduce her joint pain, muscle tension, and fatigue.

As part of the program, a user may be requested to engage with a therapy platform that is accessible via a computer program executing on a computing device. The term “user” may be used to generally refer to an individual whose posture is assessed via the therapy platform. Users can actively engage with the therapy platform or apply the therapy platform for posture assessment of other users. For example, the therapy platform could be implemented in a classroom such that a teacher can instruct students on their posture based on output from the therapy platform, or the therapy platform could be implemented in a gym such that a coach can instruct players on their posture based on output from the therapy platform. Establishing and/or maintaining good posture is important across fields, and therefore the therapy platform could be used across various industries and scenarios. The therapy platform can also actively guide users for posture improvement by generating reminders, instructions (e.g., to move or reposition), and other feedback as users engage with the therapy platform. Additionally or alternatively, the therapy platform can send continual or periodic insights of users' posture to other people (e.g., to healthcare professionals for diagnostic purposes, to academic administrators to document student engagement, etc.).

As further discussed below, a therapy platform may represent one part of the physical activity system (or simply “system”) that is designed to promote compliance with a program. Though referred to in relation to posture herein, the therapy platform may promote programs with other physical activities for a variety of activities, such as for wellness, healthcare, sports, dance, virtual reality, augmented reality, cooking, art, or any other endeavor that requires the body be positioned in a particular manner.

Generally, the therapy platform is embodied as a computer program executing on a computing device that is accessible to a user. This computing device may be coupled to one or more image sensors that capture data about the environment surrounding a user. The computing device sends image data of the user captured by these image sensors to the therapy platform for computer vision analysis. By analyzing this image data, the therapy platform may be able to establish whether the user has good posture.

Such an approach enables the therapy platform to provide personalized feedback to a user her posture. Moreover, the therapy platform may tailor its feedback based on its knowledge of user positioning. For example, the therapy platform may determine appropriate feedback based on whether a user is sitting, standing, or lying down, what type of items (e.g., chair, laptop, desk) the user is interacting with, and the user's health (e.g., whether the user has any history or condition that affects movement, such as a bending leg due to wearing a cast, slight arm angle from previous injury, etc.).

At a high level, the therapy platform is representative of a pathway for digitally engaging persons in a consistent, meaningful way. As further discussed below, other avenues of communication may be employed as well. For example, a coach may be able to interact directly with users (e.g., via text messages, email, video, etc.) in addition to communicating with those users through the therapy platform. The term “coach” may be used to generally refer to individuals who prompt, encourage, or otherwise facilitate engagement by users with programs. Similarly, users could be connected with healthcare professionals such as physical therapists, physicians, nurses, counselors, etc. For example, the therapy platform may generate interfaces through which a coach can serve as a guide, partner, or “cheerleader” for a user as she completes sessions in accordance with a program. Similarly, the therapy platform may generate interfaces through which a healthcare professional can obtain or rely on advice regarding symptoms, treatment, and the like.

As mentioned above, the approaches introduced here for rendering feedback based on posture indicators could be used across different applications. Accordingly, while embodiments may be described in the context of healthcare, features of those embodiments may be similarly applicable to other fields related to posture improvement. Similarly, while embodiments may be described in the context of “doctors,” features of those embodiments may be similarly applicable to other professionals. In addition to, or instead of, facilitating communication with healthcare professions, the therapy platform could facilitate communication with athletes, athletics coaches, dance instructors, cooking instructors, art instructors, and the like.

For the purpose of illustration, embodiments may be described with reference to particular anatomical regions, sensor data analysis techniques, and the like. However, those skilled in the art will recognize that the features are similarly applicable to other anatomical regions, computer vision techniques, and use cases. As an example, while embodiments may be described in the context of an image sensor that captures image data about the environment around a user, the features described herein may be applied by a physical activity system having any number of image sensors arranged throughout the environment. In fact, a therapy platform may establish the spatial position of different anatomical regions over time and then determine whether those spatial positions indicate proper posture or not. For example, an image sensor may be affixed to the top of a bookshelf for capturing image data of a user working at a desk. The therapy platform may be able to determine what the user's posture is like while she is working and provide feedback to the user on how to improve her posture while working. In another example, an image sensor may be placed in a kitchen above the island. The therapy platform may use image data of a user cooking in the kitchen to determine if she is maintaining proper posture while at prepping or cooking. The therapy platform may employ any number of computer vision techniques for determining posture indicators in these scenarios. Examples of computer vision techniques include image classification, object detection, object tracking, semantic segmentation, and instance segmentation.

Moreover, embodiments may be described in the context of computer-executable instructions for the purpose of illustration. However, aspects of the technology can be implemented via hardware, firmware, or software. As an example, a therapy platform may be embodied as a computer program that offers support for completing sessions as part of a program, enables communication between users and coaches and determines whether posture has improved over time. As mentioned above, the term “coach” may be used to refer to any individual that is responsible for providing direction, instructions, or supervision. Examples of such individuals include healthcare professionals, teachers, athletics coaches, dance instructors, cooking instructors, art instructors, and the like.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Therapy Platform

A therapy platform may be responsible for monitoring the posture of an individual (also called a “user,” “patient,” or “participant”) through analysis of digital images that contain her and are captured over a time period. As an example, the therapy platform may monitor the user over posture sessions (or simply “sessions”) as part of a posture program (or simply “program”). As part of the program, the user may be requested to engage with the therapy platform on a periodic basis. The frequency with which the user is requested to engage with the therapy platform may be based on factors such as the quality of the user's posture over time, an MSK condition of the user, the age of the user, the amount of progress that has been achieved, and the like.

As the user employs the therapy platform, she may be recorded by a camera of a computing device. In some instances, the camera is part of the computing device on which the posture monitoring is executed or accessed. For example, in order to initiate a session, the user may initiate a mobile application that is stored on, and executable by, her mobile phone or tablet computer, and the mobile application may instruct the user to position her mobile phone or tablet computer in such a manner that one of its cameras can record her over a time period. Note that, in some embodiments, the camera is part of another computing device. For example, the camera may be included in a peripheral computing device, such as a web camera (also called a “webcam”), that is connected to the computing device. By examining the digital images that are output by the camera, the therapy platform can monitor the user's posture over time and offer feedback for posture improvement.

As mentioned above, the therapy platform could alternatively assess posture in contexts that are unrelated to working at a desk, for example, when cooking/baking in a kitchen, driving in a vehicle, lecturing in a classroom, and more. Accordingly, while embodiments may be described in the context of a user who engages with the therapy platform for posture assessment, the features of those embodiments may be similarly applicable to individuals' posture being assessed in a group setting. Individuals whose postures are analyzed may be referred to as “users” of the therapy platform, even if these individuals have little to no opportunity to interact with the therapy platform.

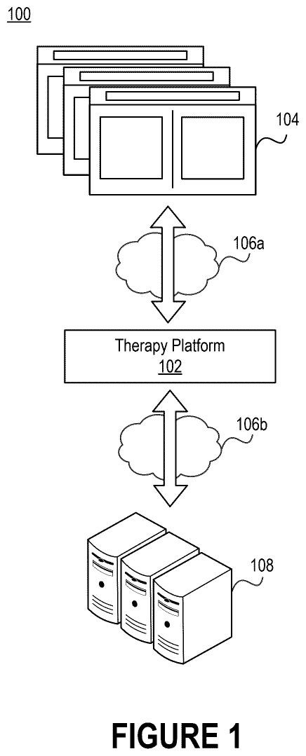

FIG. 1 illustrates an example of a network environment 100 that includes a therapy platform 102. Individuals can interact with the therapy platform 102 via interfaces 104 as further discussed below. For example, users may be able to access interfaces that are designed to guide them through sessions, present educational content, indicate progression in a program, present feedback from coaches, etc. As another example, coaches may be able to access interfaces through which information regarding completed sessions (and thus program progression) and clinical data can be reviewed, feedback can be provided, etc. Thus, interfaces 104 generated by the therapy platform 102 may serve as informative spaces for users or coaches, or the interfaces 104 generated by the therapy platform 102 may serve as collaborative spaces through which users and coaches can communicate with one another.

As shown in FIG. 1, the therapy platform 102 may reside in a network environment 100. Thus, the computing device on which the therapy platform 102 is executing may be connected to one or more networks 106a-b. The networks 106a-b can include personal area networks (PANs), local area networks (LANs), wide area networks (WANs), metropolitan area networks (MANs), cellular networks, the Internet, etc. Additionally or alternatively, the computing device can be communicatively coupled to other computing devices over a short-range wireless connectivity technology, such as Bluetooth®, Near Field Communication (NFC), Wi-Fi® Direct (also referred to as “Wi-Fi P2P”), and the like. As an example, the therapy platform 102 is embodied as a mobile application that is executable by a mobile phone or tablet computer in some embodiments. In such embodiments, the mobile phone or tablet computer may be communicatively connected to (i) one or more sensor units via a short-range wireless connectivity technology and (ii) a computer server via the Internet.

The interfaces 104 may be accessible via a web browser, desktop application, mobile application, or over-the-top (OTT) application. For example, a user may be able to access interfaces that are designed to guide her through a session in which predetermined physical activities (e.g., exercises) are to be performed a predetermined number of times via a mobile application that is executing on a mobile phone or tablet computer. As another example, a coach may be able to access interfaces through which she can review the progress of one or more users via a web browser executing on a tablet computer or laptop computer. As another example, a coach may be able to access interfaces through which she can personalize users' sessions based on, for example, their needs and progress. Accordingly, the interfaces 104 may be viewed on various computing devices depending on the nature of the therapy platform 102 and its deployment. Examples of computing devices include desktop computers, laptop computers, tablet computers, mobile phones, wearable electronic devices (e.g., watches or fitness accessories), mobile workstations (also referred to as “computer carts”), network-connected electronic devices (e.g., televisions or home assistant devices), and virtual or augmented reality systems (e.g., head-mounted displays).

In some embodiments, at least some components of the therapy platform 102 are hosted locally. That is, part of the therapy platform 102 may reside on the computing device used to access one of the interfaces 104. For example, the therapy platform 102 may be embodied as a mobile application executing on a mobile phone or tablet computer. In such embodiments, the instructions that, when executed, implement the therapy platform 102 may reside largely or entirely on the mobile phone or tablet computer. Note, however, that the mobile application may be able to access a server system 108 on which other components of the therapy platform 102 are hosted.

In other embodiments, the therapy platform 102 is executed entirely by a cloud computing service operated by, for example, Amazon Web Services®, Google Cloud Platform™, or Microsoft Azure®. In such embodiments, the therapy platform 102 may reside on a server system 108 comprised of one or more computer servers that are accessible via a network (e.g., the Internet). These computer servers can include information regarding different programs, sessions, or physical activities; computer-implemented models (or simply “models”) that indicate how anatomical regions should move when a given physical activity is performed; algorithms for processing data from which spatial position or orientation of anatomical regions can be computed, inferred, or otherwise determined; user data such as name, age, weight, ailment, enrolled program, duration of enrollment, number of sessions completed, and correspondence with coaches; and other assets.

Those skilled in the art will recognize that this information could also be distributed amongst a network-accessible server system and one or more computing devices. For example, some user data may be stored on, and processed by, her own computing device for security and privacy purposes. This information may be processed (e.g., encrypted or obfuscated) before being transmitted to the server system 108. As another example, some user data may be retrieved from an electronic health record (also referred to as an “electronic medical record”) that is maintained for the user. Electronic health records are normally maintained in storage that is managed by healthcare systems, and this storage may be accessible to the therapy platform 102 (e.g., via an application programming interface). As another example, the algorithms and models needed to process the data from which the spatial position or orientation of anatomical regions of a given individual can be computed, inferred, or otherwise determined may be stored on, or accessible to, a computing device associated with the given individual to ensure that such data can be processed in real time (e.g., as physical activities are performed as part of a session). The data could be generated by one or more sensor units that are secured to the human body of the given individual (e.g., proximate to the anatomical regions), or the data could be generated by a camera that is included in, or accessible to, the computing device used by the given individual to initiate the session.

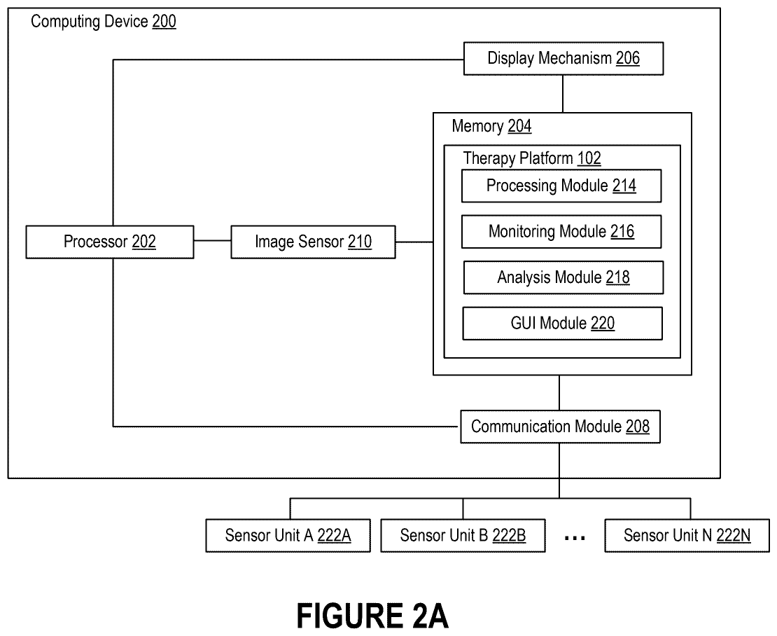

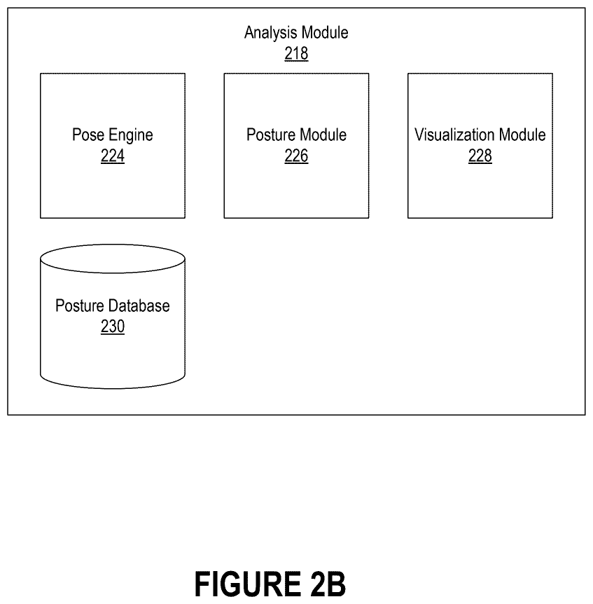

FIG. 2A illustrates an example of a computing device 200 that is able to implement a program in which a user is requested to perform physical activities, such as exercises, during sessions by a therapy platform 212. In some embodiments, the therapy platform 212 is embodied as a computer program that is executed by the computing device 200. In other embodiments, the therapy platform 212 is embodied as a computer program that is executed by another computing device (e.g., a computer server) to which the computing device 200 is communicatively connected. In such embodiments, the computing device 200 may transmit data captured by the image sensor 210 to the other to the other computing device for processing. Those skilled in the art will recognize that aspects of the computer program could also be distributed amongst multiple computing devices.

The computing device 200 can include a processor 202, memory 204, display mechanism 206, communication module 208, and image sensor 210. Each of these components is discussed in greater detail below. Those skilled in the art will recognize that different combinations of these components may be present depending on the nature of the computing device 200.

The processor 202 can have generic characteristics similar to general-purpose processors, or the processor 202 may be an application-specific integrated circuit (ASIC) that provides control functions to the computing device 200. As shown in FIG. 2A, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the therapy platform 212) and produced, retrieved, or obtained by the other components of the computing device 200. For example, data received by the communication module 208 from the image sensor 210 (via the processor 202) or sensor units 222A-N may be stored in the memory 204, or data produced by the image sensor 210 may be stored in the memory 204. Note that the memory 204 is merely an abstract representation of a storage environment. The memory 204 could be comprised of actual memory integrated circuits (also referred to as “chips”).

The display mechanism 206 can be any mechanism that is operable to visually convey information to a user (e.g., a user). For example, the display mechanism 206 may be a panel that includes light-emitting diodes (LEDs), organic LEDs, liquid crystal elements, or electrophoretic elements. In some embodiments, the display mechanism 206 is touch sensitive. Thus, a user may be able to provide input to the therapy platform 212 by interacting with the display mechanism 206.

The communication module 208 may be responsible for managing communications between the components of the computing device 300, or the communication module 208 may be responsible for managing communications with other computing devices (e.g., sensor units 220A-N of FIG. 2A or server system 108 of FIG. 1). The communication module 208 may be wireless communication circuitry that is designed to establish communication channels with other computing devices. Examples of wireless communication circuitry include chips configured for Bluetooth, Wi-Fi, NFC, and the like. Assume, for example, that the computing device 200 is associated with a user. In such a scenario, the communication module 208 may initiate and then maintain a communication channel with a network-accessible server system managed by a digital service that is responsible for enrolling and then engaging users in programs. Moreover, the communication module 208 may initiate and then maintain communication channels with one or more external image sensors and/or one or more sensor units 222A-N that are secured to different anatomical regions of the user. As further discussed below, data generated by these components may be streamed to the therapy platform 212 during a session for analysis.

The image sensor 210 may be any electronic sensor that is able to detect and convey information in order to generate images, generally in the form of image data or pixel data. Examples of image sensors include charge-coupled device (CCD) sensors and complementary metal-oxide semiconductor (CMOS) sensors. The image sensor 210 may be implemented in a camera that is implemented in the computing device 200. In some embodiments, the image sensor 210 is one of multiple image sensors implemented in the computing device 200. For example, the image sensor 210 could be included in a front- or rear-facing camera on a mobile phone. In some embodiments, the image sensor 210 may be externally connected to the computing device 200 such that the image sensor 210 captures image data of an environment and sends the image data to the processing module 214.

For convenience, the therapy platform 212 may be referred to as a computer program that resides within the memory 204. However, the therapy platform 212 could be comprised of software, firmware, or hardware implemented in, or accessible to, the computing device 200. In accordance with embodiments described herein, the therapy platform 212 may include a processing module 214, monitoring module 216, analysis module 218, and graphical user interface (GUI) module 220. These modules can be an integral part of the therapy platform 212. Alternatively, these modules can be logically separate from the therapy platform 212 but operate “alongside” it. Together, these modules may enable the therapy platform 212 to guide a user through sessions that are performed as a part of a program designed to improve performance of one or more physical activities or manage/treat a MSK condition that is affecting a particular anatomical region.

The processing module 214 can process image data obtained from the image sensor 210 over the course of a session. The image data may be used to infer a spatial position or orientation of the corresponding anatomical region. For example, the processing module 214 may perform operations (e.g., filtering noise, changing contrast, reducing size) to ensure that the data can be handled by the other modules of the therapy platform 212. As another example, the processing module 214 may temporally align the data with data obtained from another source (e.g., the sensor units 222A-N or another image sensor) if multiple data are to be used to establish the spatial position or orientation of the anatomical regions of interest.

In some embodiments, the processing module 214 additionally or alternatively processes data obtained from sensor units 222A-N attached to anatomical regions of the user over the course of the session. The processing module 214 can parse, filter or otherwise alter this data so that it is usable by the other modules of the therapy platform 212. As an example, in some embodiments, the processing module 214 may examine this data in order to ensure that multiple streams of data received from different components (e.g., Sensor Unit A 222A and Sensor Unit B 222B) are temporally aligned with one another.

Moreover, the processing module 214 may be responsible for processing information input by users through interfaces generated by the GUI module 220. For example, the GUI module 220 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 206) that she is ready to proceed with the next physical activity, that she completed the last physical activity, that she would like to temporarily pause the session, etc. These inputs can be examined by the processing module 214 before information indicative of these inputs is forwarded to another module.

The monitoring module 216 can monitor ongoing movement of the user as she completes physical activities as part of a session. While the processing module 214 may be responsible for processing data streamed to the therapy platform 212 (e.g., by the image sensor 210 or, in some embodiments, the sensor units 222A-N), the monitoring module 216 may be responsible for determining whether the user is moving as would be expected when completing a physical activity. As an example, assume that the imager sensor 210 is positioned in front of a user. During a session, the user may be instructed to perform an exercise such as a side plank in which the hips are lifted away from the ground. In such a scenario, the monitoring module 216 can examine image data generated by the image sensor 210 to determine whether the thorax and lumbar regions of the user's body are moving—either in terms of three-dimensional (3D) space or with respect to one another—as would be expected given the exercise.

The analysis module 218 may be responsible for determining adherence to individual physical activities, sets of physical activities performed during sessions, or sets of sessions performed as part of a program. The analysis module 218 can determine feedback for users performing the physical activities during posture sessions. As shown in FIG. 2B, the analysis module 218 includes a pose engine 224, a posture module 226, a visualization module 228, and a posture database 230. In some embodiments, the analysis module 218 may include a subset of the modules and data structures shown in FIG. 2B, or the analysis module 218 may include additional modules or data structures that are not shown in FIG. 2B. For example, in some embodiments, the user interface (UI) module includes or is otherwise combined with the GUI module 220 of FIG. 2A.

The pose engine 224 may be responsible for determining estimated poses of body parts as users perform physical activities. The term “estimated pose” may be used to refer to the position(s) of body part(s) of a given person—which wholly or partially may define a posture—at a given time. While poses focus on a particular body part or group of body parts, posture is defined based on how the body parts are positioned relative to one another. Body parts may include any portion of a body that performs a physical activity. A body part may refer to a single anatomical region (e.g., a hand, left elbow, torso, right foot), one anatomical region in relation to another anatomical region (e.g., a left hand in relation to a left elbow, a left hand in relation to a right hand), or a series of anatomical regions in relation to another anatomical region (e.g., fingers in relation to a wrist, left and right hands and elbows in relation to a torso). Body parts could also be particular bones or joints. Physical activities may include movements performed for wellness, sports, dance, virtual reality experiences, augmented reality experiences, physical therapy, or any other activity that requires physical movement. Some examples of physical activities include dance moves (e.g., pliés, moonwalks, shuffles, etc.), sporting techniques (e.g., football throws, soccer kicks, tennis serves, basketball layups, yoga poses, etc.), exercises (e.g., planks, hip extensions, etc.), stretches, posture techniques (e.g., standing/sitting at desk for healthy back and neck), and cooking techniques (e.g., chopping, kneading, dicing, etc.). An estimated pose can be represented by angle and orientation of one or more body parts.

The pose engine 224 determines estimated poses based on image data. The pose engine 224 can obtain image data of a user performing physical activities from the image sensor 210. The pose engine 224 can do so in response to receiving a request for estimated pose(s) from the posture module 226. In some instances, the request can include the image data. The image data can be images and/or videos of the user in an environment. The image data may depict a subset of the user's body (e.g., one or more of the user's body parts) or the user's entire body. For example, the image data may only depict the hands and feet of the user. The image data may also depict body parts of multiple users. The pose engine 224 may store the image data in the posture database 230 along with an indication of a time (or time period), date, and/or location associated with the capture of the image data.

In some embodiments, the posture database 230 may be implemented on a computing device 200 where the image sensor 210 is located. In other embodiments, the posture database 230 may be implemented in the server system of FIG. 1. The posture database 230 may be formatted to expedite posture assessment performed by the analysis module 218. For example, in some instances, the posture database 230 may be tabulated by identifiers associated with the particular image sensor 210 that captures the image data, identifiers of the users depicted in or otherwise associated with the image data, and/or identifiers of a computing device that transmitted the image data to the analysis module 218.

The pose engine 224 can apply a 3D pose estimation engine, a motion capture device, or a motion sensor unit to determine estimated poses and/or movements of the user as depicted by the image data. The pose engine 224 can also determine estimated poses and/or movements based on feature maps of the image data. For instance, the pose engine 224 can extract one or more feature maps from the image data and segment the image data into contiguous regions of pixels. Each contiguous region of pixels may be associated with a portion of the environment. The pose engine 224 can segment the image data based on objects shown in the image data and/or contrast between colors of and/or distance between the pixels. For example, the pose engine 224 may extract pixels representing the floor into a first region, a piece of furniture into a second region, a user's right hand into a third region. The pose engine 224 may use one or more machine learned models to segment the image data or may use an algorithm. For example, pixels representing a hand may have similar coloring and be within a set distance threshold of one another compared to pixels of a green wall behind the hand. The pose engine 224 may create groups of pixels each associated with a color range (e.g., light to dark green or dark yellow to light orange). For each group, the pose engine 224 may determine a weighted average location of the pixels and remove pixels from the group that are a threshold distance away from the weighted average location. The pose engine 224 may iterate upon this grouping process until every pixel is associated with a group (e.g., a segment of the image data).

The pose engine 224 extracts a feature map for each segment of the image data. A feature map is a vectorial representation of features in the image data. The pose engine 224 may extract feature maps by applying filters or feature detectors to each segment. For example, the pose engine 224 may apply a filter that detects skin to a segment and may receive, as output, a feature map highlighting which portions of the segment include skin. The pose engine 224 may store the segments and associated feature maps in the posture database 230 or another datastore.

The pose engine 224 can apply the posture module 226 to each extracted feature map. The posture module 226 may be representative of a neural network that includes a series of convolutional layers and a series of connected layers of decreasing size, and the last layer of the neural network may be a sigmoid activation function. The neural network can include a plurality of parallel branches that are configured to together estimate poses of body parts based on the feature maps. A first branch of the neural network could be configured to determine a likelihood that the portion of the environment associated with the segment includes a body part, while a second branch of the neural network could be configured to determine an estimated pose of the body part in the portion of the environment associated with the segment. Approaches to designing, training, and implementing neural networks with parallel branches is further discussed in U.S. Provisional Application No. 63/370,467, titled “Hand Presence Detection for Hand Pose Estimation,” which is incorporated by reference herein in its entirety. In some embodiments, the posture module 226 may employ an additional or alternative machine learning framework or artificial intelligence framework to the neural network to estimate poses of body parts.

For each extracted feature map, the pose engine 224 determines an estimated pose based on an output from the neural network. In some embodiments, the neural network may also output a particular body pose from a set of body poses stored in the posture database 230. In other embodiments, the neural network can output a set of likelihoods each indicative of whether the extracted feature map represents a particular body pose. The pose engine 224 may select the body pose with the highest likelihood from the set as the estimated pose. For multiple extracted feature maps input to the neural network together, the pose engine 224 may determine an estimated pose for each extracted feature map and determine a total pose based on the estimated poses. For example, the body pose module may determine that four extracted feature maps together show that the user is in a star pose (e.g., arms and legs extended diagonally outward from the torso). The pose engine 224 sends the estimated pose(s) to the posture module 226. For more than one estimated pose, the pose engine 224 orders the estimated poses based on the order the user performed the estimated poses in the image data.

The posture module 226 determines posture indicators for estimated poses. A posture indicator is a descriptor of a user's current posture. The posture indicators can include forward gaze, relaxed arms, and posture change. Forward gaze can include neck angles between the neck-to-hip and neck-to-top of the head. When the neck-to-hip angle is 0 and the neck to top of the head angle is also 0, then the user may have good neck posture. Relaxed arms can include angles between shoulder-to-hip and shoulder-to-elbow bones. When should-to-hip angle is 0 and shoulder to elbow bones is also 0 (e.g., a user's arms are at her side or resting at a 90 degree angle on arm rests), the user may have good shoulder posture. Posture change can include backbone direction in relation to shoulder-to-hip bones. When a user's backbone direction is forward or backward a threshold degree from pointing upward from the shoulder-to-hip bones, the user may have shifted posture from an ideal posture. These posture indicators can provide insight that can be used to determine whether a user is slouching, maintaining too much tension in certain body parts, craning her neck, or the like. Other posture indicators can include chin position, spine curvature, shoulder evenness, abdominal flex, hip evenness, knee evenness, knee direction, body weight distribution.

The posture module 226 can access posture indicators from the posture database 230. Each posture indicator can be associated with a set of body parts. Each body part can be associated with a range of positions and angles relative to a neutral position of the user's body. The user's body is in the neutral position when facing forward with her arms relaxed at her sides and her spine neither tensed nor arched. For example, the posture indicator “looking down” may be associated with the joint between the user's head and neck and a range of angles between 45 and 90 degrees in the x-direction (where the x-axis runs through the user's front side to the user's back side). The neutral position can include multiple position types, such as standing, sitting, etc. For instance, the user is in the neutral position when standing if her legs are straight other than a slight bend at the knees. In another example, the user is in the neutral position when sitting with her legs at a 90-degree angle and with both feet flat on the floor.

The posture module 226 receives estimated poses from the pose engine 224 and analyzes each estimated pose to determine one or more posture indicators. The posture module 226 can apply heuristic rules (or simply “rules”) to an estimated pose. The rules cause the posture module 226 to compute deviations of the user's body from the neutral position. The rules may be different for different postures. For example, the rules for a user's posture when sitting in an armchair may be different from the rules for a user's posture when sitting on bleachers. Whether the user is sitting or standing or otherwise positioned to have a different posture, the posture module 226 uses different subsets of the rules to compute deviations. The rules may be manually defined by an external operator, a programmer for a system that uses the therapy platform 102 (e.g., a hospital, school, etc.), a professional employing the therapy platform 102, or the user. The rules may additionally or alternatively be automatically defined based on input provided by the user or a professional employing the therapy platform 102. For example, a therapist may identify videos of a person showing good (or bad) posture, which the posture module 226 can analyze to determine the rules. The posture module 226 can input image data labeled with good or bad posture to train a machine learning module that determines rules that dictate posture quality.

For each deviation over an error threshold (e.g., more than a 1-degree difference, more than a 1-centimeter change in position), the posture module 226 can determine that the deviation is a significant deviation. The posture module 226 can keep a tally of the significant deviations for the received estimated poses for the user. The posture module 226 can store the tally in association with the user, a current time, and the image data in the posture database 230.

The posture module 226 can query the posture database 230 with each deviation and its associated body part(s). In some instances, the posture module 226 only queries the posture database 230 for significant deviations. The posture module 226 selects a posture indicator associated with the same body part(s) and a range of positions/angles that includes the deviation. For instance, the posture module 226 may query the posture database 230 with the body part spine at an angle 20 degrees. The posture database 230 may store the posture indicator “slouching” in association with the spine and a range of angles of 5 degrees to 90 degrees, so the posture module 226 may retrieve the posture indicator “slouching” in response to the query.

The posture module 226 can retrieve multiple posture indicators for each query. In some embodiments, the posture module 226 sends all of the posture indicators to the visualization module 228. In other embodiments, the posture module 226 can select one posture indicator to send to the visualization module 228. The posture module 226 can select the posture indicator associated with the greatest deviation or the posture indicator associated with the most number of body part(s). The posture module 226 can also select a posture indicator based on a ranking of posture indicators stored in the posture database 230. The posture indicators may be ranked by an external operator, number of times the posture indicator has been selected by the posture module 226 for the user, and/or number of times the posture indicator has been selected by the posture module 226 for multiple users of the therapy platform 102. For example, slouching may be ranked higher than the posture indicator leaning, so the posture module 226 would select slouching when selecting from the two posture indicators.

The visualization module 228 produces content related to posture assessment. The visualization module 228 sends the content to the GUI module 220 to be incorporated into graphical user interfaces (GUIs) presented for display via the display mechanism 206, and therefore may also be called the “UI module.” The display mechanism 206 can be a physical display on a computing device 200 or can be embedded in an application on the computing device 200. The visualization module 228 may create content that, when incorporated into a GUI by the GUI module 220, a user can interact with (via the display mechanism 206) for posture assessment as part of a session hosted by the therapy platform 102. For example, the visualization module 228 may create content including instructions that guide a user through a posture session, a Pilates workout, a virtual cooking class, or a physical therapy session. The instructions may include the user's avatar performing the body poses with proper form such that the user can see how her body needs to move to improve her posture. The visualization module 228 can also create content including other textual or visual descriptions of the user's current or recommended posture.

The visualization module 228 receives indications from the GUI module 220 to render content related to a user's posture. An indication can include an identifier of a user using the therapy platform 102 and a time period for posture assessment. For example, the indication may indicate that Arianna wants to use the therapy platform to monitor her posture while practicing ballet. The visualization module 228 generates content based on the indications. The content can include real-time image data of the user, textual information about her posture, and feedback for the user about how to improve her posture, which can include her avatar display how she should move to improve her posture. The visualization module 228 sends the content to the GUI module 220, which causes the display mechanism 206 to display interfaces that include the content.

The visualization module 228 receives real-time image data of the user during a session. The session can be a posture session, which guides the user to maintain proper posture over the duration of the session. The user has proper posture when maintaining the neutral position. The visualization module 228 can receive the image data from the image sensor 210 or via a network connection from another computing device or image sensor. The visualization module 228 sends the image data to the pose engine 224 and receives posture indicators based on the image data from the posture module 226. If the visualization module 228 does not receive a posture indicator from the posture module 226 in response to sending the image data to the pose engine 224, the visualization module 228 can send content that indicates for the user to adjust the image sensor 210 to better show the user in the environment to the GUI module 220 for display. The content can also include instructions to position the image sensor 210 such that a minimum number of the user's joints are depicted in the video data.

The visualization module 228 determines feedback for the user based on the posture indicators. The feedback can include description of the posture indicators, the neutral position, and how the user can move her body to improve her posture. For example, for the posture indicator “slouching,” the visualization module 228 may generate feedback for the user that tells her that she is slouching and to improve her posture, she should straighten her back such that it is flush with the back of her chair. In some embodiments, feedback for each posture indicator is stored in the posture database 230 in association with each posture indicator, and the visualization module 228 accesses the posture database 230 to retrieve feedback. The visualization module 228 can also access a tally of significant deviations associated with the image data from the posture database 230 and determines additional feedback based on the tally. The UI can send the feedback to the GUI module 220 or to an external computing device associated with a doctor, therapist, coach, or the like of the user.

The visualization module 228 sends the posture indictors and content (including feedback) to the GUI module 220. The GUI module 220 generates a GUI (also referred to as “UI” for simplicity) including the feedback for the posture indicators. In some instances, the visualization module 228 generates a UI for each posture indicator. Along with the feedback, the UI(s) can include content such as identification of the posture indicator, an avatar of the user showing how to move based on the feedback, a generic avatar showing the user how to move based on the feedback, an avatar of the user overlayed with elements representing the feedback (e.g., arrows pointing to how the user should move), and the like. The visualization module 228 transmits the UI(s) to the display mechanism 206 (or a display mechanism on another computing device) for display to the user. The visualization module 228 sends new image data to the pose engine 224 and can update the UI(s) based on new posture indicators received from the posture module 226.

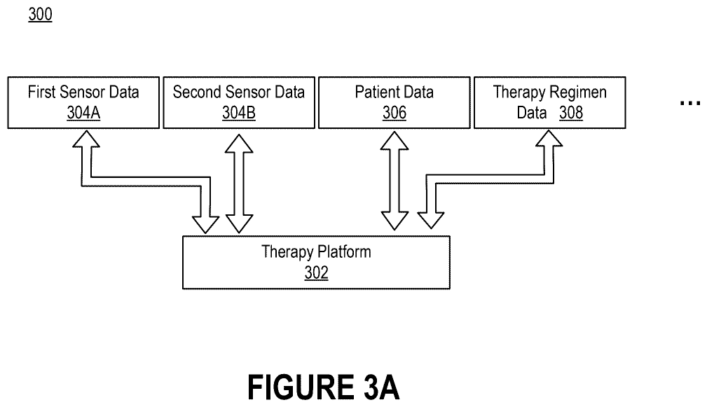

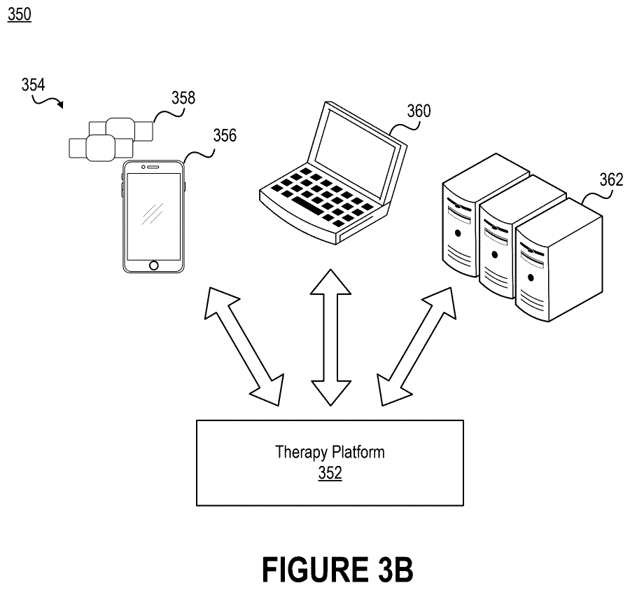

FIG. 3A depicts an example of a communication environment 300 that includes a therapy platform 302 configured to receive several types of data. Here, for example, the therapy platform 302 receives first image data 304A that captured by an image sensor 210 located in front of a user, second image data 304B generated by an image sensor 210 located behind a user, user data 306 that is representative of information regarding the user, and therapy regimen data 308 that is representative of information regarding the program in which the user is enrolled. Those skilled in the art will recognize that these types of data have been selected for the purpose of illustration. Other types of data, such as community data (e.g., information regarding adherence of cohorts of users), could also be obtained by the therapy platform 302.

These data may be obtained from multiple sources. For example, the therapy regimen data 308 may be obtained from a network-accessible server system managed by a digital service that is responsible for enrolling and then engaging users in programs. The digital service may be responsible for defining the series of physical activities to be performed during sessions based on input provided by coaches. As another example, the user data 306 may be obtained from various computing devices. For instance, some user data 306 may be obtained directly from users (e.g., who input such data during a registration procedure or during a session), while other user data 306 may be obtained from employers (e.g., who are promoting or facilitating a wellness program) or healthcare facilities such as hospitals and clinics. Additionally or alternatively, user data 306 could be obtained from another computer program that is executing on, or accessible to, the computing device on which the therapy platform 302 resides. For example, the therapy platform 302 may retrieve user data 306 from a computer program that is associated with a healthcare system through which the user receives treatment. As another example, the therapy platform 302 may retrieve user data 306 from a computer program that establishes, tracks, or monitors the health of the user (e.g., by measuring steps taken, calories consumed, or heart rate).

FIG. 3B depicts another example of a communication environment 350 that includes a therapy platform 352 configured to obtain data from one or more sources. Here, the therapy platform 352 may obtain data from a therapy system 354 comprised of a tablet computer 356 and one or more sensor units 358 (such as image sensors), personal computer 360, or network-accessible server system 362 (collectively referred to as the “networked devices”). For example, the therapy platform 352 may obtain data regarding movement of a user during a session from the therapy system 354 and other data (e.g., therapy regimen information, models of exercise-induced movements, feedback from coaches, and processing operations) from the personal computer 360 or network-accessible server system 362.

The networked devices can be connected to the therapy platform 352 via one or more networks. These networks can include PANs, LANs, WANs, MANS, cellular networks, the Internet, etc. Additionally or alternatively, the networked devices may communicate with one another over a short-range wireless connectivity technology. For example, if the therapy platform 352 resides on the tablet computer 356, data may be obtained from the sensor units over a Bluetooth communication channel, while data may be obtained from the network-accessible server system 362 over the Internet via a Wi-Fi communication channel.

Embodiments of the communication environment 350 may include a subset of the networked devices. For example, some embodiments of the communication environment 350 include a therapy platform 352 that obtains data from the therapy system 354 (and, more specifically, from the sensor units 358) in real time as physical activities as performed during a session and additional data from the network-accessible server system 362. This additional data may be obtained periodically (e.g., on a daily or weekly basis, or when a session is initiated).

### Posture Session Process

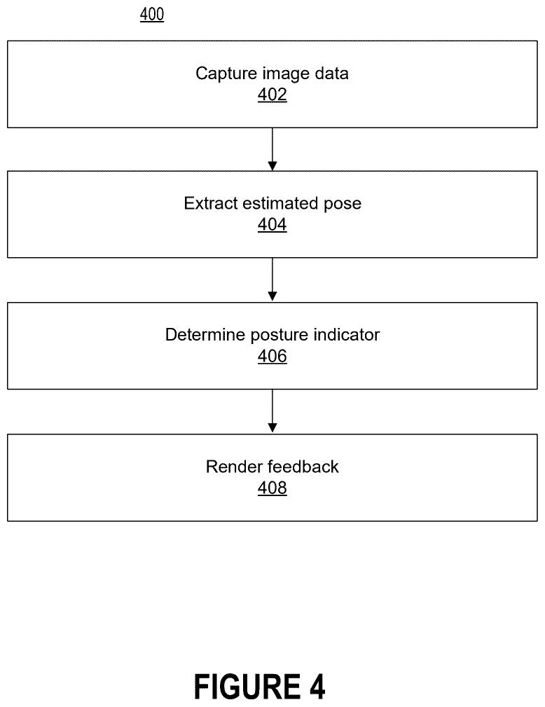

FIG. 4 depicts a flow diagram of a process 400 for determining feedback for a user based on posture indicators, according to one embodiment. The therapy platform 102 can employ the process 400 as part of guiding a user through a set of physical activities for a session. In some embodiments, the therapy platform 102 can perform additional or alternative steps to those shown in FIG. 4 and/or use additional or alternative modules to those described herein to perform the process 400.

Initially, the image sensor 210 captures 402 image or video data. Image data may be used to refer to pixel data and related metadata that is collectively representative of one or more digital images. For illustration, the approach to assessing posture is described in the context of analyzing image data associated with a single digital image. However, those skilled in the art will recognize that the approach may be similarly applicable if performed on a series of digital images arranged in a temporal data. For example, the series of digital images may be representative of frames of a digital video, and therefore the term “video data” may be used synonymously with “image data” for simplicity.

The image sensor 210 captures 402 video data over a time period. In some embodiments, an image sensor from another computing device 200 captures the video data and sends the video data to the computing device 200 of the therapy platform 102. The time period can be from the start of a posture session or from when the image sensor 210 captured a last set of video data. The video data depicts a user in an environment during a posture session. For example, Cassidy may start a posture session via the therapy platform 102. She can position the image sensor 210 to capture video data of her sitting at a desk, and the image sensor 210 begins capturing video data of Cassidy sitting at the desk for the posture session. The image sensor 210 sends the video data to the visualization module 228.

Simultaneously to capturing the video data over the time period, the therapy platform 102 extracts 404 an estimated pose of the user based on the video data, determines 406 a posture indicator based on the estimated pose, and renders 408 feedback for the user via a UI. The visualization module 228 sends the video data to the pose engine 224, which extracts 404 an estimated pose of the user based on the video. To do this, the pose engine 224 can extract a feature map from the video data or can extract a feature map for each frame of the video data. The pose engine 224 can apply a neural network to the feature map(s), where the neural network outputs data indicative of one or more estimated poses shown in the video data.

The pose engine 224 sends the estimated pose (or estimated poses, in some embodiments) to the posture module 226. The posture module 226 determines 406 a posture indicator (or posture indicators) by heuristically analyzing the estimated pose. The posture indicator may be a forward gaze, relaxed arms, a posture change, and the like. Forward gaze can indicate neck angle between neck-hip and neck-headtop bones, relaxed arms can indicate arm angle between shoulder-hip and shoulder-elbow bones, and posture change can indicate backbone direction given by shoulder-hip bone. For example, based on video data of Nora tilting her head to the right, the posture module 226 may determine the posture indicator of relaxed arms with an angle of 30 degrees.

The posture module 226 sends the posture indicator to the visualization module 228, which renders feedback 408 and other information (e.g. content) related to posture assessment for the user based on the posture indicator. The visualization module 228 send the feedback and other information to the GUI module 220, which creates a UI including the feedback for the user and renders the UI for display at the display mechanism 206 of the computing device 200. The UI can include the video data overlaid with an avatar of the user in the neutral position, such that the user can see how to move to improve his posture. The UI can also include textual description of the feedback, images or videos depicting body parts related to the posture indicator, and the like. The visualization module 228 renders new information for display at a UI upon receiving new video data and subsequent posture indicators to guide the user during a posture session. For example, the visualization module 228 can receive video data of Joshua coding at his desk and render feedback for Joshua that he should straighten his neck and his spine for better posture. The visualization module 228 can capture real-time video data of Joshua making these improvements and render information indicating that he has improved his posture and/or provide updated feedback. The visualization module 228 sends this feedback and information to the GUI module 220 for display to Joshua.

The process 400 may include additional or alternative steps to those shown in FIG. 4. For example, in some embodiments, the visualization module 228 sends the feedback to an external computing device of a professional (physical therapist, coach, or doctor) associated with the user, thus allowing the professional to provide treatment or coaching to the user based on the feedback. In some embodiments, the visualization module 228 renders instructions on the display mechanism 206 of the computing device 200. The instructions can indicate that the computing device 200 needs to be positioned in the environment such that a minimum number of the user's joints are depicted in the video data.

In some embodiments, the posture module 226 can compute deviations between the estimated pose and a neutral position and determine selects significant deviations from the deviations. The posture module 226 can select significant deviations by comparing the value of each deviation to a threshold value and/or a time period associated with the deviation (e.g., how long the deviation occurred) to a threshold time. If the value is greater than the threshold value and/or the time period is greater than the threshold time, the posture module 226 can determine that the deviation is a significant deviation. The posture module 226 can add each significant deviation to a tally stored in the posture database 230. The visualization module 228 can determine the feedback based on the tally. For example, the visualization module 228 can determine a score associated with a user's posture based on the tally.

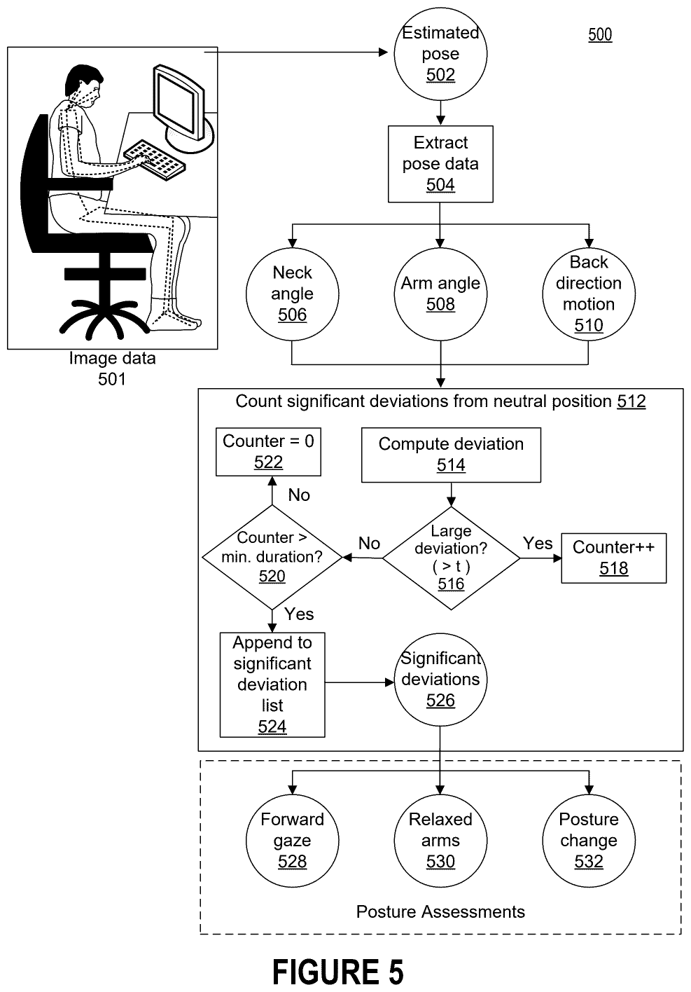

FIG. 5 depicts a flow diagram of a process 500 determining posture indicators (528, 530, 532), according to one embodiment. The therapy platform 102 can employ the process 500 as part of determining feedback for a user during a posture session. In some embodiments, the therapy platform 102 can perform additional or alternative steps to those shown in FIG. 5 and/or use additional or alternative modules to those described herein to perform the process 500.

The posture module 226 can receive an estimated pose 502 from the pose engine 224 based on image data 501 of a user's posture session. Though the image data 501 in FIG. 5 depicts a user sitting down, the image data could include the user in other positions, such as standing. The posture module can extract 504 pose data. The pose data can include of neck angle 506, arm angle 508, and back direction motion 510. The posture module 226 counts 512 the number of significant deviations from the neutral position based on the pose data. To do so, the posture module 226 computes deviations 514 based on the pose data. For each deviation, posture module 226 compares 516 the deviation to a threshold value (t). If the deviation exceeds the threshold value, the posture module 226 adds 518 to a counter of time. If the deviation does not exceed the threshold value, the posture module 226 compares 520 the counter of time to a minimum duration. If the posture module 226 determines that the counter does not exceed the minimum duration, the posture module 522 sets the counter to zero. Otherwise, the posture module 226 appends 524 the deviation to a list of significant deviations 526. The posture module uses the significant deviations 526 to determine the posture assessments including the posture indicators forward gaze 528, relaxed arms 530, and posture change 532.

The process 500 may include additional or alternative steps to those shown in FIG. 5. For example, in some embodiments, the posture module 226 sends the posture indicators to the visualization module 228. The visualization module 228 determines feedback for the user based on the posture indicators and renders a UI with the feedback at the user's computing device 200. The UI can include textual description of each posture indicator compared to the neutral position. For example, the UI can label an avatar of Kat with postures indicators to show that her forward gaze 528 is at 30 degrees, her relaxed arms 530 is at 90 degrees, and her posture change 532 is directed to her front left.

### UI Examples

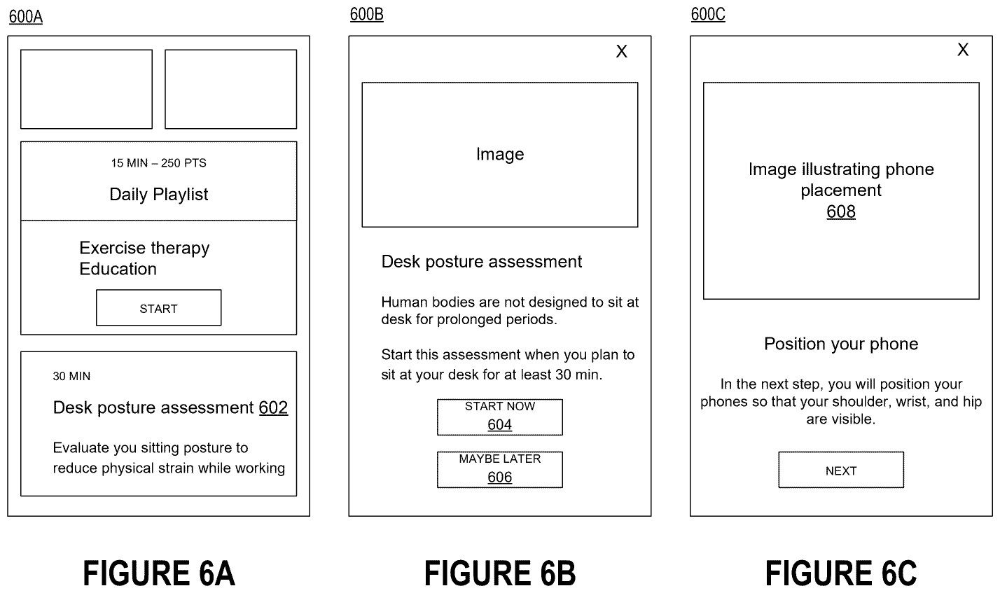

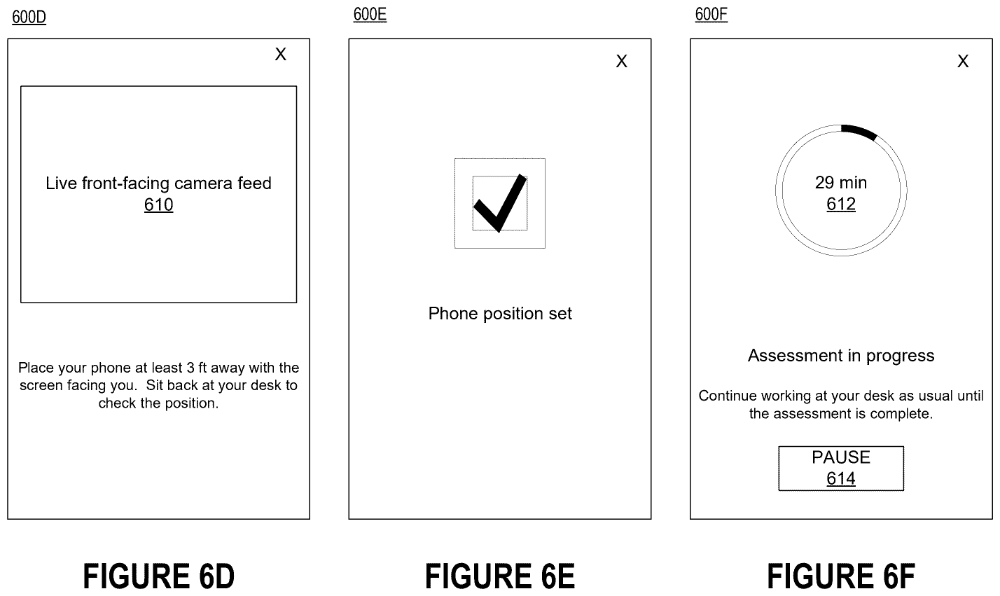

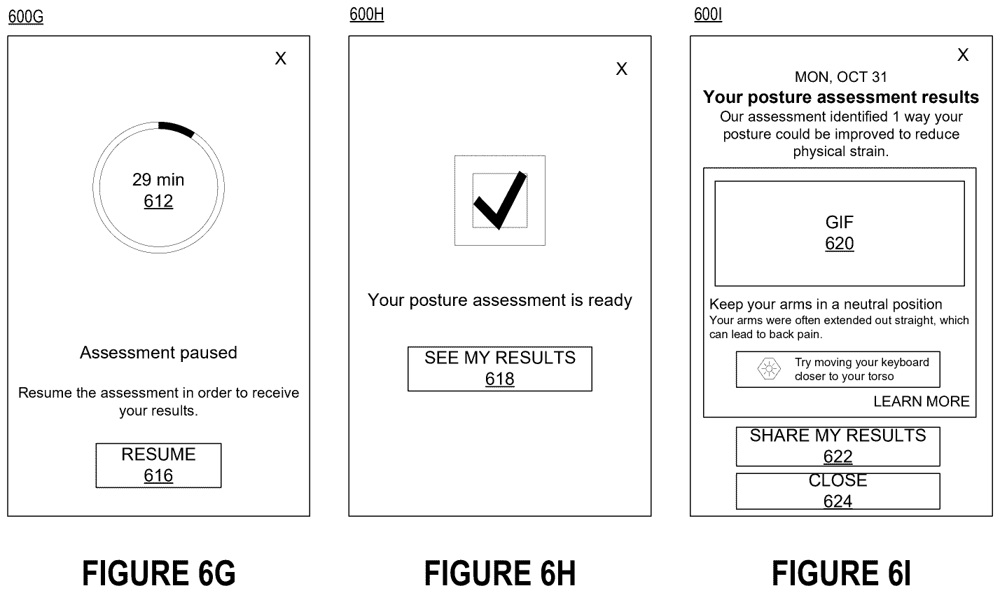

FIGS. 6A-6I are examples of user interfaces 600 that the visualization module 228 may render during a posture session. In some embodiments, additional or alternative user interfaces 600 to those shown in FIGS. 6A-6I can be rendered by the visualization module 228. Further, although the following user interfaces are described with respect to a desk posture assessment, similar user interfaces 600 can be used for other types of posture or therapy sessions enabled by the therapy platform 102.

FIG. 6A depicts a user interface 600A with interactive elements for a user to select between to engage with a therapy platform. The interactive elements include a widget 602 for desk posture assessment, which a user can interact with to learn more about a posture session. FIG. 6B shows a user interface 600B with a description of a posture session for desk posture assessment, and a user can interact with a start widget 604 to begin the posture session or with a later widget 606 to return to user interface 600A. FIG. 6C shows a user interface 600C including an image 608 of how to place the computing device 200 to capture image data for the posture session.

FIG. 6D depicts a user interface 600D with a camera feed 610 from the image sensor 210 of the computing device 200 and information about how to set the computing device 200 for the posture session. In some embodiments, the image data may not be from a live camera feed 610 but rather prerecorded video data. For example, the image data may be prerecorded in academic or medical settings to maintain data privacy. Further, the therapy platform 102 may not retain the image data from the camera feed 610 for similar concerns. In some instances, the camera feed 610 on the user interface 600D may depict a skeletal frame of a user, either augmenting image data or without image data. The camera feed 610 may also be augmented with feedback on how a user should move for posture improvement.

FIG. 6E shows a user interface 600E with verification of the computing device 200 positioning for the posture session. FIG. 6F shows a user interface 600F including a timer 612 depicting time remaining in the posture session and a pause widget 614 that the use can interact with the pause the posture session. The image sensor 210 can captured image data of the user for the posture assessment while this user interface 600F is being displayed. FIG. 6G shows a user interface 600G depicting the timer 612 when the posture session is paused. The user interface 600G also includes a resume widget 616 that the user can interact with to resume the posture session.

FIG. 6H depicts a user interface 600H indicating that the user has completed posture assessment for the posture session. When this user interface 600H is shown, the image sensor 210 has finished capturing image data and sent the image data to the analysis module 218. The image sensor 210 may have sent the image data in real-time or may send the entirety of the image data once this user interface 600H is displayed. The user can interact with the results widget 618 to see feedback generated by the visualization module 228 for the posture session. FIG. 6l shows a user interface 600I with feedback for the user for the posture session. The feedback includes textual information of how the user deviated from the neutral position and how the user can improve her posture. The user interface 600I also includes a gif 620, which can show example body parts or an avatar of the user that moves to show how the user should move to improve her posture and/or how the user was deviating from the neutral position during the posture assessment. The user interface 600I includes a share widget 622 that the user can interact with to send the feedback to an external computing device and a close widget 624 that the user can interact with to end the posture session.

### Processing System

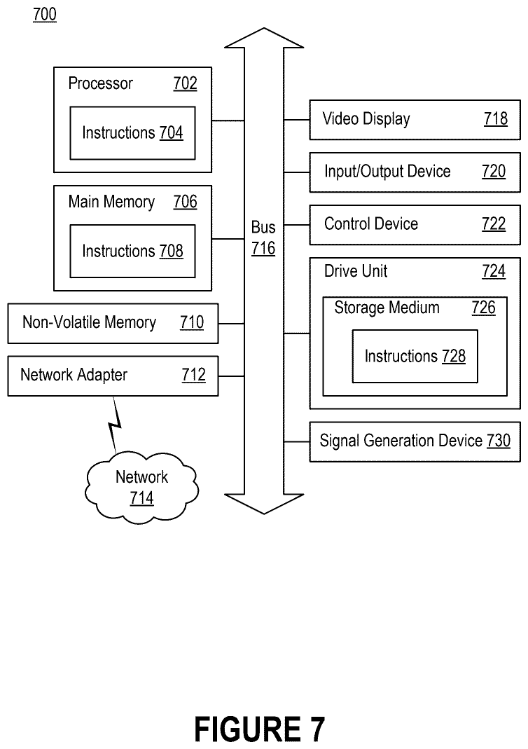

FIG. 7 is a block diagram illustrating an example of a processing system 700 in which at least some operations described herein can be implemented. For example, components of the processing system 700 may be hosted on a computing device that includes a therapy platform (e.g., therapy platform 102 of FIGS. 1 and 2A or therapy platforms 302, 352 of FIGS. 3A-B).

The processing system 700 may include a processor 702, main memory 706, non-volatile memory 710, network adapter 712, video display 718, input/output device 720, control device 722 (e.g., a keyboard or pointing device), drive unit 724 including a storage medium 726, and signal generation device 730 that are communicatively connected to a bus 716. The bus 716 is illustrated as an abstraction that represents one or more physical buses or point-to-point connections that are connected by appropriate bridges, adapters, or controllers. The bus 716, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 706, non-volatile memory 710, and storage medium 726 are shown to be a single medium, the terms “machine-readable medium” and “storage medium” should be taken to include a single medium or multiple media (e.g., a centralized/distributed database and/or associated caches and servers) that store one or more sets of instructions 728. The terms “machine-readable medium” and “storage medium” shall also be taken to include any medium that is capable of storing, encoding, or carrying a set of instructions for execution by the processing system 700.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in a computing device. When read and executed by the processors 702, the instruction(s) cause the processing system 700 to perform operations to execute elements involving the various aspects of the present disclosure.

Further examples of machine- and computer-readable media include recordable-type media, such as volatile memory and non-volatile memory 710, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 712 enables the processing system 700 to mediate data in a network 714 with an entity that is external to the processing system 700 through any communication protocol supported by the processing system 700 and the external entity. The network adapter 712 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method performed by a computer program executing on a computing device, the method comprising:
capturing video data over a time period, the video data depicting a user in an environment;
simultaneously to capturing the video data over the time period:
extracting an estimated pose of the user based on the video data;
determining a posture indicator by heuristically analyzing the estimated pose; and
rendering, via a display on the computing device, feedback for the user based on the posture indicator.

2. The method of claim 1, wherein the feedback is sent to a second computing device of a physical therapist, coach, or doctor.

3. The method of claim 1, further comprising:
rendering, via the display of the computing device, instructions to position the computing device in the environment such that a minimum number of the user's joints are depicted in the video data.

4. The method of claim 1, wherein the posture indicator is a forward gaze, relaxed arms, or posture change.

5. The method of claim 4, wherein:
forward gaze comprises neck angle between neck-hip and neck-headtop bones;
relaxed arms comprises arm angle between shoulder-hip and shoulder-elbow bones; and
posture change comprises backbone direction given by shoulder-hip bone.

6. The method of claim 1, wherein extracting the estimated pose of the user based on the video data comprises:
extracting a feature map from the video data; and
applying a pose engine to the feature map.

7. The method of claim 6, wherein the pose engine based on a neural network.

8. The method of claim 1, further comprising:
computing deviations between the estimated pose and a neutral position;
adding, to a tally of deviations, each significant deviation of the deviations; and
determining the feedback based on the tally.

9. The method of claim 8, wherein significant deviations are determined by:
for each deviation:
responsive to determining a value of the deviation is greater than a threshold and determining a time period associated with the deviation is greater than a threshold amount of time, determining that the deviation is a significant deviation.

10. A method performed by a computer program executing on a computing device, the method comprising:
capturing image data over a time period, the image data depicting a user in an environment;
extracting an estimated pose of the user based on the image data;
determining a posture indicator by heuristically analyzing the estimated pose; and
rendering, via a display on the computing device, feedback for the user based on the posture indicator.

11. The method of claim 10, wherein the feedback is sent to a second computing device of a physical therapist, coach, or doctor.

12. The method of claim 10, further comprising:
rendering, via the display of the computing device, instructions to position the computing device in the environment such that a minimum number of the user's joints are depicted in the image data.

13. The method of claim 10, wherein the posture indicator is a forward gaze, relaxed arms, or posture change.

14. The method of claim 13, wherein:
forward gaze comprises neck angle between neck-hip and neck-headtop bones;
relaxed arms comprises arm angle between shoulder-hip and shoulder-elbow bones; and
posture change comprises backbone direction given by shoulder-hip bone.

15. The method of claim 10, wherein extracting the estimated pose of the user based on the image data comprises:
extracting a feature map from the image data; and
applying a neural network to the feature map.

16. The method of claim 10, further comprising:
computing deviations between the estimated pose and a neutral position;
adding, to a tally of deviations, each significant deviation of the deviations; and
determining the feedback based on the tally.

17. The method of claim 16, wherein significant deviations are determined by:
for each deviation:
responsive to determining a value of the deviation is greater than a threshold and determining a time period associated with the deviation is greater than a threshold amount of time, determining that the deviation is a significant deviation.

18. A computing device comprising:
a display;
a processor; and
a memory storing instructions that, when executed by the processor, cause the processor to perform operations comprising:
capturing video data over a time period, the video data depicting a user in an environment;
simultaneously to capturing the video data over the time period:
extracting an estimated pose of the user based on the video data;
determining a posture indicator by heuristically analyzing the estimated pose; and
rendering, via the display, feedback for the user based on the posture indicator.

19. The computing device of claim 18, wherein the feedback is sent to a second computing device of a physical therapist, coach, or doctor.

20. The computing device of claim 18, wherein the operations further comprise:
rendering, via the display of the computing device, instructions to position the computing device in the environment such that a minimum number of the user's joints are depicted in the video data.

21. The computing device of claim 18, wherein the posture indicator is a forward gaze, relaxed arms, or posture change.
